(19) United States
(12) Patent Application Publication
(10) Pub. No.: US 2007/0017748 A1
(43) Pub. Date: Jan. 25, 2007

(54) Scissors-type lifting platform

(76) Inventors: Gerold Heckert, Sachsenheim (DE); Klaus Pfleghaar, Weil am Rhein (DE)

Correspondence Address: JANSSON, SHUPE, MUNGER & ANTARAMIAN, LTD, 245 MAIN STREET, RACINE, WI, 53403, US

(21) Appl. No.: 11/455,516

(22) Filed: Jun. 19, 2006

Related U.S. Application Data
(63) Continuation of application No. PCT/EP04/14470, filed on Dec. 20, 2004.

(30) Foreign Application Priority Data
Jun. 30, 2005 (WO) 2005/058742
Dec. 18, 2003 (DE) DE 103 59 490.6

(51) Int. Cl. B66F 7/06

(52) U.S. Cl. 187/211

(57) ABSTRACT

The invention concerns a scissors-type elevating platform, comprising two pairs of scissors, spaced apart in parallel and arranged between a base unit (20) and a support unit (10) moving up and down. Said pairs of scissors have each two scissors arms (1, 2) pivotable relative to each other about a scissors axle (9). Said device also comprises an elevating mechanism having at least one spreader unit (4) which can reciprocate between the scissors arms (1, 2) to raise and lower the support unit and which is coupled to a winding shaft (12) via a traction element assembly (5) capable of being wound on the winding shaft (12) driven by a motor, said traction element assembly comprising at least two flat traction bands spaced apart in parallel. The width of the traction bands is selected so as to ensure, when the support unit (10) is raised, that the bands are superimposed on the winding shaft. A spreader curve (3) co-operating with the spreader unit (4), for influencing the drive torque produced by the drive motor (14), the tensile loads acting in the traction element assembly (5) and/or the evolution of the lifting movement speed, is arranged respectively on at least part of the scissors arms, on either side, oriented towards the spreader unit (4) relative to the scissors axle (9). In order to ensure reliable operating conditions, the spreader unit (4) is loosely coupled to the traction element assembly (5) and one end of the traction element assembly (5), opposite to the winding shaft (12), is connected to the support unit (10) or to the scissors arms (1,2) via a retaining element of the traction element mounting (7), outside the spreader unit (4). The control of the drive motor(s) (14) and the outline of the spreader curve are mutually coordinated, the variation on the path of travel of the winding radius of the traction bands on the winding shaft (12) being integrated, such that a predetermined evolution of the torque of the drive motor(s) (14) or a predetermined evolution of the tensile loads in the traction element assembly (5) is reproduced on the path of travel, the drive motor(s) being controlled or regulated.

### CROSS REFERENCE TO RELATED APPLICATION

This application is a continuation of PCT Application No. PCT/EPO4/014470 having an international filing date of Dec. 20, 2004 and published, in German, on Jun. 30, 2005 as international publication number WO 2005/058742, which designates at least one country in addition to the United States and which claims priority from German Application No. 103 59 490.6 filed Dec. 18, 2003, each of these applications being incorporated by reference in their entirety.

### FIELD OF INVENTION

The invention relates to a scissors lift with two parallel and separated scissors arranged between a base unit on one side and a support unit that is moved up and down on the other side. Each scissor has two scissor arms that pivot relative to each other. The lift also has a spreader unit that reciprocates between the two scissor arms to raise and lower the support unit by means of a traction element arrangement that has a motor-driven winding roller with at least two flat, parallel separated traction belts, where the width of the traction belts is such that when raising the support unit, the winding of each of the belts on the winding roller in a position-dependent, superimposed manner is ensured. A spreader curve, positioned on at least one of the scissor arms so that it opposes the spreader unit relative to the pivoting axle, interacts with the spreader unit to influence the torque generated by the motor, the loads acting on the traction element arrangement and/or the change in the lifting movement speed.

### BACKGROUND OF THE INVENTION

Such a scissors-type lifting platform is given in DE 100 01 910 A1. For this known scissors type lifting platform, a scissors arrangement, with two spaced apart and parallel scissors, is mounted between a base unit and a reciprocating support device for carrying a load. The scissor arms of each scissors are spread using a lifting device, in that between the two scissor arms of each scissors an lifting carriage is pulled towards the scissors axle by means of a traction means and a drive that is connected to it for lifting the support device. Between the respective scissor arms is a lifting curve, from which the lifting carriage rolls off so that the shape of the lifting curve influences the lifting movement. An advantage of this know scissors type lifting platform is a traction element arrangement with preferably several belt-type tractions means in the form of flat bands, which are wound up around a winding drum mounted on the base unit and parallel to the scissors axle. The flat bands ensure a defined winding up of the flat belts superimposed layer upon layer, so that the coil radius increases by one belt thickness for each drum rotation.

A further similar scissors type lifting platform is shown in DE 1 99 21 436 A1. In this known scissors type lifting platform, the lifting device has, likewise, several flat traction bands. These are in the form of flat toothed belts and are fed around a drive shaft, over which they are moved. The traction bands have a bottom drum and a top drum on which the lifting carriage is mounted so that it rolls off between the scissor arms.

### SUMMARY OF THE INVENTION

The invention solves the problem of developing a scissors type lifting platform, of the known state of the art, such that the lifting movement is further improved.

This problem is solved according to the criteria of claim 1. To this end, the spreader unit is loosely coupled to the traction element arrangement and, an end of the traction element arrangement, which is turned away from the winding roller, is connected to the lifting table or a separate holding device by a traction element mounting outside the spreader unit. Also to this end, activation of the at least one drive motor and the spreader curve, taking into account the varying coil radii of the traction bands on the drive roller, which vary with the lifting stroke, are matched to each other so that, a specified torque curve of the at least one drive motor occurs within the lifting stroke or a specified curve of the traction forces in the traction element arrangement under the control or regulation of the at least one drive motor is reproduced.

Due to the spreader unit, which is moved like a lose pulley by the traction element arrangement, for example a spreader carriage or a roller unit mounted so that it commutes, relatively low forces result from the lifting movement, so that the movement path can be precisely controlled with the measures detailed later, while wear of the traction bands and other elements of the lifting device is reduced. With this design, a spreader curve can be mounted on each of the two spreading scissor arms, the shape of which can be used to help in defining the movement path of the spreader unit or the lift.

An advantage of the design for the layout, with drive motor and gearbox on one side and the traction element arrangement as well as the remaining configuration of the lifting device on the other side is that the curve of the torque or the traction forces in the traction element arrangement are so specified that the curve, at least in a middle section of the lifting stroke which is greater than the sum of the start and end sections of the lifting stroke, is constant.

If, in so doing, the torque curve is held constant, then the traction forces acting on the traction bands are highest at the start of winding, i.e. when the coil radius is still small, while they reduce with increasing coil radius, i.e. increasing lift. Therefore, the risk of band tearing in the critical higher positions of the support unit is smaller than in the lower positions. In a short start and/or end section of the lifting stroke, which is for example less than ¼ or ⅕ of the total lifting stroke, the torque curve or the curve of the tractions forces acting on the traction bands can be designed to be smaller, if required.

A further advantage of the lift control is that, at the same time, the lifting speed, at least in a middle section of the lifting stroke which is larger than the sum of the start and end sections of the lifting stroke, is held constant.

Moreover, it is intended that the traction forces in the traction element assembly and/or the torque that is to be applied by the, at least one, drive motor during the lifting movement be matched to the changing band lengths and the coil radius, which depends on the changing band lengths. Therefore the scissors type lifting platform can be configured to meet the actual conditions of use, e.g. dependent on the loads to be lifted. In the alternative, drive motors and gearboxes of increased or reduced power as well as other drive elements of increased or reduced stability can be used, dependent upon the selected self-varying length of the traction bands.

Good torque and speed consistency are maintained by the design of the invention such that the increasing coil radius due to winding and the curvature of the spreader curve are well matched to each other in a manner where a specified lifting ratio is maintained during the lifting stroke, the lifting ratio being defined by the ratio of band length to a phase of the lifting stroke. The lifting ratio, which is maintained essentially constant, gives at the start, i.e. at a still relatively uncritical lifting phase where coil diameters are still small, a relatively high traction load in the band. The traction load in the band is reduced, however, with increasing lift until it attains its lowest value when the platform reaches its top position where the coil diameter is at its greatest value. As a result of this design, the safety of the system with respect to traction element breaking is increased.

The traction element assembly has at least one traction band with steel cables embedded in plastic or rubber material to contribute to the precise control of the movement path and its continuously high reliability. At the same time, it is also advantageous that two, three or four flat traction bands be provided so that emergency running can be maintained if one of the traction bands should snap. In any case, backward movement of the support unit or lifting platform is reliably prevented.

Moreover, more reliable operation is achieved by having several parallel running traction elements of the traction element assembly connected to the traction element mounting and for each traction element, providing separate traction element damage monitoring. The traction element monitor serves to detect damage and, in particular, tearing of the traction element, e.g. due to slack tensioning. This can be indicated to the user and/or recorded using an evaluation arrangement within a diagnosis arrangement that monitors the date and time or other relevant operating parameters such as the running time of the affected band or the lifting cycles.

Various advantageous embodiments of the invention have a drive arrangement fixed relative to the base unit, the support unit or two parallel scissor arms and have has a winding drum with its axis parallel to the scissors axle.

Further alternative embodiments are characterized in that the traction element mounting is fixed relative to the base unit, the support unit or two parallel scissor arms. Insofar as a winding change for the traction element or the traction element mounting is necessary, these can be mounted in a pivoting manner.

It is intended that the traction element be fed around a guiding axle, which is connected to the moveable lower end section of the scissor arm that moves along the base unit and/or is fed around a guiding axle which is connected to the moveable upper end section of the other scissor arm that moves along the support unit. This results in relatively flat positioning of the scissors arms at the start of movement, especially caused by the spreader unit, while, during raising, the lifting movement is caused by a traction force acting on the moving end(s) of the relevant scissor arm(s) and applied by the traction element.

A further advantageous embodiment of the invention involves integration of the base unit in a vehicle body and having the drive arrangement coupled to the vehicle's own drive via a drive shaft or having a separate drive.

A favorable embodiment of the invention achieves the lowest possible torque using a small gearbox size with its associated cost advantages by having the traction element fed around both a guide element in the area of a moving bearing for the relevant lower end section of the scissor arm and also around a further guide element in the area of a moving bearing for the relevant upper end section of the scissor arm. Here also, especially for opposing spreader curves, which are mounted on opposing arm sections, relatively flat spreader curves can be used, which is advantageous if a small overall height is required.

The shape of the spreader curves can be configured so that the lifting speed remains the same over the whole lifting stroke or has certain desired properties, e.g. an accelerating section in the lowest lifting area.

The invention will now be explained in more detail based on the implementation examples and making reference to the diagrams.

### BRIEF DESCRIPTION OF THE DRAWINGS

FIG. 1a) to f) are various schematic side views of preferred versions of a scissors type lifting platform in accordance with this invention, which differ primarily in the guidance of the traction elements and their connection; and

FIG. 2 is a schematic view of the connection of the traction elements to a traction element mounting.

### DETAILED DESCRIPTION OF PREFERRED EMBODIMENTS

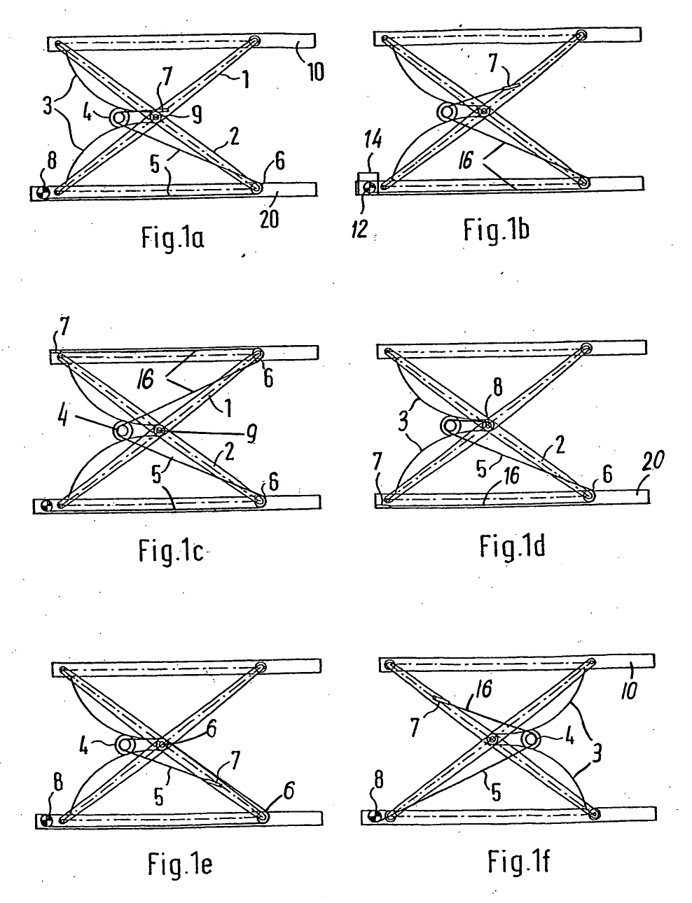

As can be seen in the schematic side views of the various embodiments of a scissors type lifting platform in accordance with this invention illustrated in FIGS. 1a)-1f), each version of the scissors type lifting platform has a scissors arrangement, comprising opposing scissor arms 1, 2 that cross at a scissor axle 9. The lower end sections of the arms are supported on a base unit 20, e.g. a floor frame or vehicle base frame, while the upper end sections are supported on a support unit 10, whereby one of the scissor arms 1 has its top end section fixed on the support unit 10 and its bottom end section horizontally displaceable over the base unit 20 and the other scissor arm 2 has its top end section horizontally displaceable over the support unit 10 and its bottom end section fixed on the base unit 20 and whereby at the bearing point pivoting movement is possible. Each lifting platform has two parallel, separated scissors, whereby a spreader unit 4, e.g. a spreader carriage, is arranged between the scissor arms 1, 2 of the scissors to raise the support unit 10, together with any load placed on it. The spreader unit 4 is coupled via a traction element assembly 5 to a drive mechanism 8.

The traction element assembly 5 preferably comprises several, e.g. two, three, four or five, flat, band-type traction elements or traction bands 16, each of which comprises several steel cables embedded in plastic or rubber. Such traction bands are sufficiently bendy and can transfer high tensile loads.

The parallel arrangement of several such traction elements increases the safety of the whole lifting system. Also possible, although less suitable, would be sufficiently bendy hawsers or chain traction elements, e.g. chains.

The traction bands 16 are connected at one end to a winding drum or shaft 12, driven by a drive motor 14, and at the other end to a traction element mounting 7. The bands are routed around the spreader unit 4 is such a manner that the latter is driven in the manner of a loose roller between the respective scissor arms 1, 2. Between the sections of scissor arms 1, 2 adjacent to the spreader unit 4, spreader curves 3 are mounted along whose outline the spreader unit 4 rolls by means of one or more double-sided rollers. The traction element mounting 7 on one end and winder shaft 12 of the drive mechanism 8 on the other end can be arranged differently with respect to the scissors type lifting platform. This is shown in FIGS. 1a) to 1f) whereby one or more guide elements 6, each having an axis of rotation parallel to the scissors axle 9, is also provided traction element assembly 5.

Thus FIG. 1a) shows an embodiment where the traction element mounting 7 is attached in the area of the scissors axle 9 and the traction bands 16 are arranged around a rotating guide element 6 in the area of the moving support for the corresponding bottom end section of the scissor arm 2 and the winding shaft 12 is mounted in the area of the base unit 20 near to the bearing point of the bottom end section of the other scissor arm 1. In winding the traction bands 16 on the winding shaft 12 by means of the drive motor 14, the lifting movement is achieved both by the drawing together of the bottom scissor arm sections and also by the drawing in of the spreader unit 4 towards the scissors axle 9, whereby the lifting movement in the area of the flatter lying scissor arms 1, 2, is in particular effected by the spreader unit 4 while when as the support unit 10 is lifted higher, the lifting movement is increasingly provided by the pulling upon the moveable bottom end sections of the scissor arms 2.

At the same time, the drive motor 14, can, for example, be mounted outside alongside a floor frame or relevant guide element of the base unit and have one or two gear motors for direct driving of the winding shaft. It would also be possible to mount the drive motor 14 within the frame of the base unit 20. However, to simplify installation and reduce the overall height, an arrangement outside the frame is preferable. If the traction element arrangement 5 has one or more band-type traction elements or traction bands 16, then these are wound up layer upon layer during lifting so that their coil radius increases, in a defined manner, by the thickness of the traction element for each rotation of the winding shaft 12. Thus unambiguous control of the lifting movement is achieved.

At the same time, the lifting movement is additionally influenced by the outlines of the spreader curves 3, which are calculated to be dependent upon the desired properties of the lifting system or which may also be specified as simple geometric outlines, e.g. curves of constant radius. The control or regulation of the at least one drive motor 14 is achieved using a motor control unit in a specified control curve for the torque or the traction force in the traction bands 16. This curve can be programmed if necessary.

In the example shown in FIG. 1 b), the traction element mounting 7 is, in contract with FIG. 1 a), mounted on the upper section of the two parallel scissor arms 1 which is furthest away from the spreader unit 4. The spatially fixed traction element mounting 7 is mounted so that it is free to rotate according to the changing angle of the attached traction bands 16.

In the example shown in FIG. 1 c), the traction bands 16, in contrast to the version shown in FIG. 1 b), are additionally fed around a second guide element 6 mounted in the upper displaceable section of the parallel scissors arms 1 and then along support unit 10 towards traction element mounting 7 fixed to support unit 10 adjacent to the upper end section of the other scissors arms 2. This results in a closing movement both on the lower displaceable section of scissor arm 2 and also to the upper displaceable section of scissor arm 1 so that the forces for the lifting movement are likewise divided in a particular fashion and thereby provide a particularly favorable torque curve and low design, especially with opposing spreader curves 3.

According to the example of FIG. 1 d), the traction element mounting 7 is fixed in the area of the lower, pivotable support point of the scissor arm 1 on the base unit 20 and the traction bands of traction element arrangement 5 are arranged around a guide element 6 on the lower section of the other scissor arm 2 in the area of its displaceable support to the base unit, while the winder shaft 12 is mounted on the scissors axle.

According to FIG. 1 e), although the winding shaft 12 and a guide element 6 are mounted as shown in FIGS. 1 a) or 1 b), traction bands are fed from this first guide element 6 out over a further guide element on the scissors axle 9 and around the spreader unit 4 to the traction element mounting 7 on the lower section of the scissor arm 2, which is opposite to the spreader unit relative to the scissors axle. Also here there is a drawing together of the lower scissors during the lifting movement and spreading by means of the spreader unit 4.

In the example according to FIG. 1 f), where the winding shaft 12 is mounted in accordance as shown in FIGS. 1 a) or 1 b), the spreader unit 4 is mounted opposite to the winding shaft 12 relative to the scissors axle 9 on the spreader curves formed in this location. The traction bands of traction element arrangement 5 are fed from the winding shaft around the spreader unit 4 to the traction element mounting 7 mounted on the upper section of the scissor arm 2 which is opposite to the spreader unit 4 relative to the scissors axle 9. For this version, the lifting motion is solely provided by the spreader unit 4.

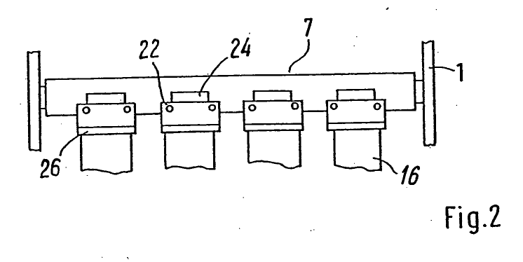

FIG. 2 shows an implementation example of a connection of three or four traction bands to the traction element mounting 7, which is, in this example, mounted between the two parallel, separated scissor arms 1 in a rotating manner. The traction element mounting 7 can include a fastening unit 22 with one or several tensioning elements 24 and monitoring elements 26. The tensioning elements 24 can be used to set the traction bands to the same tension. The monitoring elements 26 can be used to determine if a traction element is torn or has snapped. The traction element monitoring can be used to generate an appropriate message for the user, e.g. a display, and, if required, can also trigger switching off the drive motor. Furthermore, diagnosis features can be implemented and faults can be saved with appropriate extra information, such as date and time or suitable operating parameters.

The traction element mounting 7 is configured as follows: Each band end is clamped to a short drum section which is assigned to it, for which advantageously, a round drum section is cut and used as a clamping piece, which is then securely clamped using screws on the end of the relevant traction band which is placed on the drum section. The clamped band end is then wound, for example, two or two and a half times around the drum section, before it is first fed around either spreader unit 4 or a guide element on the end section of a scissor arm. If the band is placed under load, then it tightens under its own friction, such that the clamping point is nearly completely relieved. This ensures that the strength of the traction element mounting 7 is at least as strong as the tear strength of the traction band. The drum sections can, moreover, be separately mounted on respective mounting elements or on a single through mounting part. The end sections of the traction bands are fixed to the winding shaft 12 in a corresponding fashion. Because the band always runs in a way that is tangentially independent of the lifting position in respect of the drum sections of the traction element mounting 7, at this point a rotating version is not required.

The lifting system can be suitably designed for any particular application using the listed measures. The load on the traction elements, as well as the torque on the winding shaft 12 of the driving mechanism 8 depend on the selected guide system with the guide elements 6 and the configuration of the spreader curve outlines. An advantageous design of the lifting system provides for uniform loading of the essential components of the lifting system. The spreader curve outline can, for example, be so configured as to match the control of the drive motor so that the loading of the traction bands 16 or of the traction element assembly 5 over the whole lifting stroke remains constant or so that the torque to be applied to the winder shaft 12 over the main middle section of the lifting stroke remains constant.

At the same time, at the beginning and/or end of the lifting stroke, a reduced torque can be made available to achieve gentle starting or tapering off of the lifting movement. In the case of a constant torque, the traction loading of the traction band is highest at the beginning of lifting when the coil diameter is smallest and the lifting table is in its lowest position. Such loading falls the higher the table is lifted until, at the highest position of the table when the coil diameter is greatest, it reaches its lowest value. This design ensures additionally that the safety of the lifting system is increased in respect to the breakage of the traction element assembly 5.

The drive torque and/or the traction forces in the traction element assembly can additionally and in an appropriate suitable fashion be stored in the control arrangement of the motor drive or according to specified functions preset movement courses carried out, in which case the spreader curve 3 and the coil radius are also considered. Also, during lifting, changing band lengths of the traction bands can be matched to the respective requirements, whereby, with reference to a given lifting stroke, longer, changing band lengths during winding-up (or unwinding), require lower traction forces in the bands and application of a lower torque to the winding shaft 12 and vice-versa. With longer changing band lengths of the traction bands, a higher rotation speed of the winding shaft must result, for the same lifting speed, as with shorter changing band lengths. Thereby, it should also be considered, that the coil radius for different, changing band lengths, also changes at a correspondingly different speed, for which the spreader curves and/or the or the torque curve and or the curve of the traction forces in the traction bands must be adjusted.

The guidance of the traction element assembly 5 in the area of the relevant upper and/or lower scissor arm sections yields, in comparison to band guidance directly between the winder shaft and spreader roller, a considerably lower force on the spreader rollers, especially in the raised position, so that the spreader unit 4 can accordingly be more favorably dimensioned.

It is also conceivable that, instead of a winding up of the traction bands, a reciprocating movement of the end section most distant from the traction element mounting 7 or both end

1-12. (canceled)

13. A scissors-type lifting platform comprising:
two parallel and spaced-apart scissors, each scissor having pivotally-connected first and second scissor arms and each scissor arm having a lower end secured to a base unit and a upper end secured to a support unit wherein the scissors are adapted to elevate the support unit from a lowered position to a raised position over a lifting stroke;
a traction element assembly having a winding shaft, a motor to drive the winding shaft, and at least two flat, parallel and spaced-apart traction bands, each traction band having a first end secured with respect to the winding shaft and having a width configured to remain in a position-dependent, superimposed manner when the bands are wound upon the winding shaft to raise the support unit;
a spreader unit movably positioned between the two scissors arms of each scissors, the spreader unit being mechanically engaged with respect to the traction element assembly to allow the spreader unit to be reciprocatingly driven;
a spreader curve secured upon at least one of the scissor arms and facing the spreader unit, the spreader curve being configured to slidably interact with respect to the spreader unit in a manner whereby the spreader curve influences a torque generated by the motor, forces acting upon the traction element arrangement, or a speed of the raising of the support unit;
a traction element mounting spaced apart from the winding shaft and having a second end of each traction band secured with respect thereto; and
a control unit adapted to regulate the motor to generate a specific torque wherein the control unit is configured to achieve a desired torque curve based upon the configuration of the spreader curve, a configuration of the traction element assembly, or a length of the traction bands whereby at least one value of the torque of the motor is selected over the lifting stroke.

14. The scissors-type lifting platform of claim 13 wherein the torque curve is selected such that the torque remains constant during at least a middle section of the lifting stroke, the middle section being greater than the sum of start and end sections of the lifting stroke.

15. The scissors-type lifting platform of claim 13 wherein the torque curve is selected such that a lifting speed of the platform remains constant during at least a middle section of the lifting stroke, the middle section being greater than the sum of start and end sections of the lifting stroke.

16. The scissors-type lifting platform of claim 13 wherein the control unit is further configured to achieve a desired curve of traction forces acting upon the traction element assembly based upon the configuration of the spreader curve, the configuration of the traction element assembly, or the length of the traction bands whereby at least one value of the traction force is selected over the lifting stroke.

17. The scissors-type lifting platform of claim 13 wherein the bands define a coil radius when wound upon the winding shaft and the configuration of the spreader curve is adapted to the coil radius so that during the lifting stroke a specified lifting ratio is maintained.

18. The scissors-type lifting platform of claim 13 wherein the traction bands comprise steel cables embedded in plastic or rubber material.

19. The scissors-type lifting platform of claim 18 wherein at least one traction band element includes a tension monitoring element.

20. The scissors-type lifting platform of claim 13 wherein each scissor arm pivots about a scissors axle, the winding shaft and the motor are situated at a fixed position with respect to the base unit, and the winding shaft has an axis parallel to the scissors axle.

21. The scissors-type lifting platform of claim 20 wherein the traction element mounting is rigidly mounted to the support unit.

22. The scissors-type lifting platform of claim 20 wherein the traction element mounting is rigidly mounted to one of the scissor arms.

23. The scissors-type lifting platform of claim 13 wherein each scissor arm pivots about a scissors axle and the traction element assembly includes at least one guide element, the guide element having an axis parallel to the scissors axle and the traction bands are disposed thereabout.

24. The scissors-type lifting platform of claim 23 wherein the traction bands define a path between the winding shaft and the traction element mounting and the guide element is positioned along the path between the winding shaft and the spreader unit.

25. The scissors-type lifting platform of claim 24 wherein the lower end of each first scissor arm is pivotally mounted at bearing points on the base unit and the lower end of each second scissor arm is slidably mounted at moving supports on the base unit;
the winding shaft is mounted adjacent to the bearing points; and the guide element is mounted to and extends between the lower ends of each second scissor arm adjacent to the moving supports.

26. The scissors-type lifting platform of claim 13 wherein the upper end of each first scissor arm is slidably mounted at moving supports on the support unit and the traction element assembly includes a second guide element mounted to and extending between the upper ends of each first scissor arm adjacent to the moving supports on the support unit.

27. The scissors-type lifting platform of claim 13 wherein the base unit is integrated into a body of a vehicle and the motor to drive the winding shaft is the drive mechanism of the vehicle.
